(19) United States
(12) Patent Application Publication
(10) Pub. No.: US 2011/0280377 A1
(43) Pub. Date: Nov. 17, 2011

(54) THERMIONIC SURFACE EMITTER AND ASSOCIATED METHOD TO OPERATE AN X-RAY TUBE

(76) Inventors: Joerg Freudenberger, Kalchreuth (DE); Gunter Roehrich, Erlangen (DE)

(21) Appl. No.: 13/102,112

(22) Filed: May 6, 2011

(30) Foreign Application Priority Data
May 11, 2010 (DE) 10 2010 020 151.0

(51) Int. Cl. H01J 35/06; H01J 1/15

(52) U.S. Cl. 378/136; 313/341

(57) ABSTRACT

In a thermionic surface emitter and an associated method to operate an x-ray tube, the surface emitter has a conductor path in its emission surface, the conductor path having at least one current entrance point and at least one current exit point. In the thermionic surface emitter, the width of the conductor path is variable i.e. is non-constant or non-uniform. The electrical resistance of the emitter structure thus varies along the heating current path, with the consequence that a symmetrical emission structure can be achieved at a working point established by the hardware geometry.

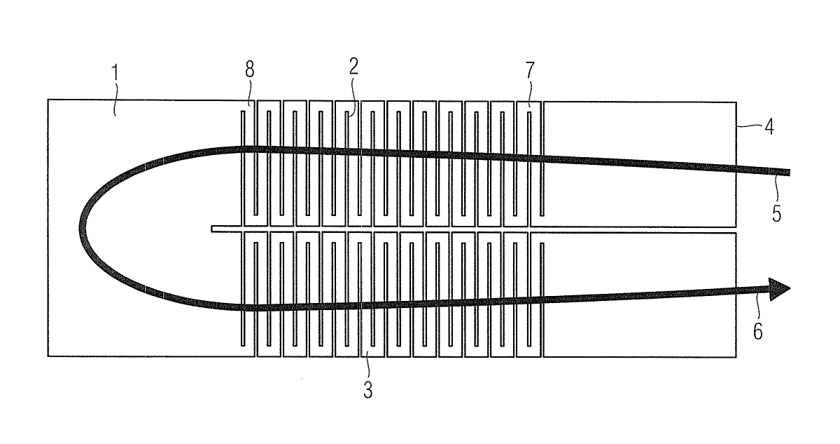

### BACKGROUND OF THE INVENTION

1. Field of the Invention

The invention concerns a thermionic surface emitter whose emission surface has conductor traces that are formed by slits in the emission surface, as well as an associated method to operate an x-ray tube.

2. Description of the Prior Art

Thermionic surface emitters that can be heated by electrical current flow—for example as described in DE 10 2006 018 633—are used in x-ray tubes. The part of the emitter that forms the emission surface is formed of one or more thin plates that are produced from a high temperature-resistant metal such as tungsten. In order to achieve emission in a defined region of the plate surface, the emitter must be heated to a high temperature of approximately 2000-2500 degrees Celsius. This occurs by means of electrical current and the intrinsic electrical resistance of the emitter material. In order to achieve a defined ohmic resistance, the plate material must be structured by precisely as many cuts or slits as possible being introduced. The emitter plate of such a thermionic surface emitter is provided with heating current terminals (connectors) via which a heating current is conducted through the emitter plate. Due to the high temperature to which the emitter plate is heated, electrons are emitted from the emitter plate and accelerated toward an anode by means of a high voltage. The emitted electrons are focused via a focusing system on the way from the emitter plate toward the anode. Upon impact of the electrons in a focal spot on the anode (which is likewise produced from a high temperature-resistant material such as tungsten), x-ray radiation is created by the braking of the electrons in the anode material. The goal of the focusing is for the electrons to strike the anode in an optimally narrow range and with an optimally uniform electron distribution density. Particularly in the use of the x-ray tube in the high resolution imaging (for example in medical diagnostic apparatuses), a high image quality can thereby be achieved. The electron density distribution can be affected by the arrangement of the slits introduced into the emitter plate.

However, in addition to the uniform heating effect produced by the heating current, a heating effect unavoidably occurs because the current to be emitted at a particular location must arrive only at this location via the emitter structures. This current, known as the tube current, is active as an additional heating current on the path toward its designated location and intensifies the heating effect. Measurements in the development of the invention have shown that an asymmetrical focal spot arises with increasing tube current. This leads to unwanted side effects, for example to the degradation of the image quality of the x-ray system.

In the known embodiments of thermionic surface emitters, this effect is not taken into account in the production of a thermionic surface emitter, or is accepted in the sense of a compromise by symmetrical feeding of the tube current to both terminals of the heating current.

### SUMMARY OF THE INVENTION

An object of the invention is to overcome this disadvantage and to provide an improved thermionic surface emitter and an associated improved method in which the focal spot retains its symmetrical shape.

In accordance with the invention, this object is achieved by a thermionic surface emitter with a conductor path or run in its emission surface, the conductor path having at least one current entrance point and at least one current exit point. The width of the conductor path is non-constant along its length in the conducting direction. For example, a conductor path with smaller width causes a higher heating voltage drop at the smaller-width portion of the conductor path and therefore a higher local temperature is achieved. A conductor path with greater width, for example, causes the heating voltage drop at the conductor to be less, and therefore a lower temperature is achieved locally. Due to the non-constant (non-uniform) width of the conductor path, the electrical resistance of the emitter structure along the heating current path varies advantageously, with the consequence that a symmetrical emission structure can be achieved at the working point established by the hardware geometry. A “symmetrical emission structure” means a distribution of the emitted electrons that is mirror-symmetrical in one plane.

In one embodiment of the invention, the width of the conductor trace can decrease such that a symmetrical focal spot can be generated on an anode. The symmetrical emissions structure leads to the situation that the electron beam is symmetrically expanded. In an invariant focusing device, a symmetrical focal spot is thereby generated at the anode location. Improvements in the image quality can thus be achieved, in particular in high-resolution imaging by means of x-ray radiation. In particular in the medical field, a higher image quality means that tissue structures can be better resolved and that a medical diagnosis can thus be created more precisely and exactly.

In a further embodiment of the invention, the width of the conductor path can decrease from the current entrance point to the current exit point. A conductor path having a width that decreases with increasing distance from the current entrance point advantageously causes the tube current to decrease with increasing distance from the current entrance point.

Furthermore, the conductor path can have a serpentine course. An advantage of a serpentine course of the conductor path is that it can be produced more simply than, for example, a conductor path that follows spiral-shaped curve.

In a further embodiment, the conductor path can be formed by slits in the emitter surface. A serpentine course of the conductor path thus can be generated in a simple manner.

The width of the conductor path can decrease from a width of 0.307 mm at the current entrance point to a width of 0.277 mm at the current exit point.

The invention also encompasses a method to operate an x-ray tube with a thermionic surface emitter with a conductor path in its emission surface, wherein the conductor path has at least one current entrance point and at least one current exit point. In this method, the width of the conductor path is varied between the current entrance point and the current exit point such that a symmetrical focal spot can be generated on an anode.

### BRIEF DESCRIPTION OF THE DRAWINGS

The single FIGURE is a plain view of a portion of an emitter plate of a thermionic surface emitter in accordance with the invention.

### DESCRIPTION OF THE PREFERRED EMBODIMENTS

The FIGURE shows a partial view of an emitter plate 1 of a thermionic surface emitter according to the invention. A conductor path 3 running in a serpentine course is fashioned by introduced slits 2. In order to achieve emission in a defined region of the emitter plate 1, the emitter must be heated to a high temperature. This occurs by means of a heating current that is supplied via a current entrance point 4 to the conductor path 3 and that flows in the indicated flow direction 5 to a current exit point 6.

In the shown embodiment, the width of the conductor path 3 decreases with increasing distance from the current entrance point 4 by the widths of the slits 2 increasing. A first conductor path segment 7 thus has a greater width than a second conductor trace segment 8. In contrast to this, the slits 2 in the first conductor path segment 7 are narrower than the slits 2 in the second conductor trace segment 8. A wide conductor trace 3 as in the first conductor trace segment 7 means that the heating voltage drop in that segment of the conductor path 3 is lower, and therefore a lower temperature is locally achieved. A narrow conductor path 3 as in the second conductor path segment 8 means that the heating voltage drop at this segment of the conductor path 3 decreases, and therefore a higher local temperature is achieved.

The electrical resistance of the emitter structure thus varies along the conductor trace 3, and a symmetrical emission structure can be achieved at a working point established by the hardware geometry. The symmetrical emission structure leads to the situation that the emission structure of the electron beam is symmetrically expanded in comparison to an emitter plate with invariant width of the conductor trace 3. A symmetrical focal spot is thereby generated at the anode location given an invariant focusing device.

Although modifications and changes may be suggested by those skilled in the art, it is the intention of the inventor to embody within the patent warranted hereon all changes and modifications as reasonably and properly come within the scope of his contribution to the art.

We claim as our invention:

1. A thermionic surface emitter comprising:
a thermionic emitter body having an emission surface comprising a conductor path having a length defined between a current entrance point to said thermionic emitter body and a current exit point from said thermionic emitter body; and
said conductor path having a width that is non-constant along said length.

2. A thermionic surface emitter as claimed in claim 1 wherein said width of said conductor path decreases to cause generation of a symmetrical focal spot on an anode struck by electrons emitted from said emission surface.

3. A thermionic surface emitter as claimed in claim 1 wherein said width of said conductor path decreases from said current entrance point to said current exit point.

4. A thermionic surface emitter as claimed in claim 1 wherein said conductor path follows a serpentine course along said length.

5. A thermionic surface emitter as claimed in claim 4 wherein said thermionic emitter body has opposite sides, and wherein said serpentine course is formed by slits extending from said sides into said thermionic emitter body.

6. A thermionic surface emitter as claimed in claim 5 wherein said slits have different widths that give said current path said width that is non-uniform along said length of said conductor path.

7. A thermionic surface emitter as claimed in claim 1 wherein said width of said conductor path decreases from 0.307 mm to 0.277 mm.

8. A method for operating an x-ray tube comprising a thermionic surface emitter having an emission surface from which electrons are emitted, and an anode that is struck at a focal spot by said electrons to produce x-rays, said method comprising the steps of:
defining a conductor path at said emission surface of said thermionic surface emitter having a length between a current entrance point of said thermionic surface emitter and a current exit point from said thermionic surface emitter; and
causing said focal spot on said anode to be symmetrical by selectively varying a width of said conductor path along said length.
